(19) United States
(12) Patent Application Publication
(10) Pub. No.: US 2018/0009831 A1
(43) Pub. Date: Jan. 11, 2018

(54) PROCESS FOR THE PREPARATION OF NOVEL POLYMORPHIC FORMS OF 5-FLUORO-1,3-DIHYDRO-1-HYDROXY-2,1- BENZOXABOROLE

(71) Applicant: Apicore US LLC, Somerset, NJ (US)

(72) Inventors: Ravishanker Kovi, Monroe, NJ (US); KeshavRao Rapole, Edison, NJ (US); Ashish Naik, Piscataway, NJ (US); Vishal Ramani, Old Bridge, NJ (US)

(73) Assignee: Apicore US LLC, Somerset, NJ (US)

(21) Appl. No.: 15/641,856

(22) Filed: Jul. 5, 2017

Related U.S. Application Data
(60) Provisional application No. 62/358,775, filed on Jul. 6, 2016.

(51) Int. Cl. C07F 5/04

(52) U.S. Cl. CPC C07F 5/04; C07B 2200/13

(57) ABSTRACT

Novel polymorphic forms of tavaborole, Form A and Form B, and methods of making same are disclosed. Methods are disclosed for the manufacture of the novel polymorphic Forms A and B. Methods include dissolving tavaborole in a pharmaceutically acceptable solvent to obtain a mixture, heating the mixture until a clear solution is obtained, cooling the clear solution, stirring the clear solution to obtain a crystalline product, filtering the crystalline product, and drying the crystalline product to obtain the pharmaceutically acceptable crystalline form of tavaborole. Pharmaceutical composition are disclosed including a pharmaceutically acceptable crystalline form of tavaborole Form A and/or Form B.

### CROSS-REFERENCE TO RELATED APPLICATIONS

This application claims the benefit of U.S. Provisional Patent Application Ser. No. 62/358,775 filed Jul. 6, 2016, the entirety of which is incorporated herein by reference.

### FIELD OF THE INVENTION

This invention relates to 5-fluoro-2,1-benzoxaborol-1(3H)-ol (tavaborole), and specifically, to novel polymorphic forms of tavaborole and methods of making same.

### BACKGROUND OF THE INVENTION

Tavaborole is a boron-containing small molecule chemically known as 5-fluoro-2,1-benzoxaborol-1(3H)-ol having the Formula (I):

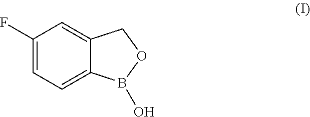 [SMILES: OB1OCc2cc(F)ccc21]

Tavaborole is a topical antifungal agent marketed in the United States under the brand name KERYDIN® for the treatment of onychomycosis, a fungal infection of the toe and fingernails.

### SUMMARY OF THE INVENTION

Novel polymorphic forms of tavaborole, Form A and Form B, are disclosed. Form A and Form B are stable forms of crystalline tavaborole. In general, the novel crystalline forms A and B of tavaborole are pharmaceutically acceptable solid forms.

Form A and Form B disclosed herein have enhanced stability and dissolution properties that can be easily formulated into pharmaceutical compositions. Therefore, in further embodiments, the novel polymorphic forms of tavaborole disclosed herein may be employed in pharmaceutical compositions which include pharmaceutically acceptable carriers and optionally pharmaceutically acceptable excipients.

In still further embodiments, methods are disclosed for the manufacture of the novel polymorphic forms of tavaborole. In some aspects, the novel Form A and Form B tavaborole solid forms are conveniently prepared by dissolving any known solid form or wet cake of tavaborole in a solvent including one or more of alcohol-water, methanol, ethanol, n-propanol, isopropanol (IPA), n-butanol, t-butanol, tetrahydrofuran, ethyl acetate, hexane, cyclohexane, dichloromethane, toluene, diisopropyl ether and acetone.

Various experiments employing different solvents resulted in x-ray powder diffraction data showing two polymorphic forms of tavaborole, Form A and Form B. The crystal solid forms were obtained by crystallization from different solvents and co-solvents under various conditions. In one embodiment crystalline tavaborole Form A is disclosed having an X-ray powder diffractogram (XRPD) including peaks at 2-theta angles of 26.958±2°, 26.187±2° and 14.283±2°. In certain embodiments the crystalline tavaborole Form A has an XPRD pattern as shown in FIG. 1.

In another embodiment crystalline tavaborole Form B is disclosed having an XRPD including peaks at 2-theta angles of 25.514±2°, 12.716±2° and 6.388±2°. In certain embodiments the crystalline tavaborole Form B has an XRPD pattern as shown in FIG. 2.

In one or more embodiments a method for preparation of a pharmaceutically acceptable crystalline form of tavaborole includes the steps of dissolving tavaborole in a pharmaceutically acceptable solvent to obtain a mixture; heating the mixture until a clear solution is obtained; cooling the clear solution; stirring the clear solution to obtain a crystalline product; filtering the crystalline product; and drying the crystalline product to obtain the pharmaceutically acceptable crystalline form of tavaborole.

The pharmaceutically acceptable solvent may be selected from one or more of water, methanol, ethanol, m-propanol, IPA, n-butanol, t-butanol, tetrahydrofuran, ethyl acetate, hexane, cyclohexane, dichloromethane, toluene, didisopropyl ether and acetone.

In some embodiments the pharmaceutically acceptable solvent is a mixture of C1-C5 alcohol, and the method further includes adding water to the mixture under warm conditions, wherein the cooling step involves cooling the clear solution to −5 to 0° C.

In other embodiments the pharmaceutically acceptable solvent is ethyl acetate.

In yet another embodiment, Form A tavaborole is prepared using a process involving crystallizing from ethyl acetate (C1-C5 acetates) and a hydrocarbon co-solvent such as but not limited to toluene, benzene, hexane, cyclohexane, heptane and pentane with a ratio of 3:1.

The method may include the further step of adding hexane to the heated mixture prior to the cooling step and the pharmaceutically acceptable crystalline form of tavaborole is obtained as crystalline form A. The crystalline Form A so obtained may have an XRPD having at least one peak at diffraction 2-theta angle selected from 26.96, 26.19, and 14.28±2° theta. The crystalline form A of tavaborole so obtained may have an XPRD pattern as shown in FIG. 1.

In accordance with another embodiment, Form A tavaborole is prepared using a column with ethyl acetate-hexane solvent.

In some embodiments the pharmaceutically acceptable solvent is ethyl acetate and/or water and no additional solvent is employed, and the mixture is heated to about 55-60° C. and the clear solution is cooled to room temperature so that the pharmaceutically acceptable crystalline form of tavaborole is obtained as crystalline form B. The crystalline form B so obtained may have an XRPD having at least one peak at diffraction 2-theta angle selected from 25.51, 12.72 and 6.39±2° theta. The crystalline form B so obtained may have an XPRD pattern as shown in FIG. 2. In another embodiment, a method of making Form B tavaborole is provided which employs ethyl acetate dissolved in warm conditions and then cooled to room temperature, and stirred for 2 h. The chromatographic purity of Form B tavaborole so prepared is about 99.9% performed by High Performance Liquid Chromatography (HPLC).

In still further embodiments, Form B tavaborole is prepared using a solvent mixture of alcohols (C1-C5) and water with a ratio of 3:1.

In yet still further embodiments, Form B tavaborole is prepared using a hexane slurry.

In another embodiment, Form B tavaborole is prepared after lyophilization of tavaborole using water miscible solvents such as but not limited to methanol in water.

The presently disclosed processes are simple and in some embodiments provide crystalline Forms A and B of tavaborole in a single step.

### BRIEF DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a graphical depiction of an X-ray powder diffractogram (XRPD) of tavaborole solid Form A according to an embodiment of the present disclosure; and

FIG. 2 is a graphical depiction of an X-ray powder diffractogram of tavaborole solid Form B according to an embodiment of the present disclosure.

### DETAILED DESCRIPTION OF THE INVENTION

The present invention now will be described more fully hereinafter with reference to the accompanying examples and experiments, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “room temperature” as used herein refers to temperatures in the range of about 20 to 35° C.

Polymorphism is a phenomenon relating to the occurrence of different crystalline forms for one molecule. There may be several different crystalline forms for the same molecule with distinct crystal structures and varying in physical properties such as melting point, XRPD pattern and FTIR spectrum. These polymorphs are thus distinct solid forms which share the molecular formula of the compound from which the crystals are made. Some polymorphs may have distinct advantageous physical properties such as chemical stability, physical stability, hygroscopicity, solubility, dissolution rate, morphology and/or bioavailability. By way of example, a polymorph which is non-hygroscopic may be preferred in order to ensure the chemical and physical quality during the storage of the active substance itself and during the shelf-life of a solid finished dosage form containing the active substance without the need of special and expensive packaging.

The preparation process of a crystalline form plays an important role in the development of an active pharmaceutical ingredient. The crystallization process should be robust and reliably produce the desired crystalline form in polymorphically pure form.

The acceptable amount of solvent in an active pharmaceutical ingredient is strictly regulated, e.g., by ICH guidelines for residual solvents.

Novel pharmaceutically acceptable solid crystalline forms of tavaborole, herein identified as the polymorphs Form A and Form B are disclosed.

Processes for the preparation of Form A and Form B involve dissolving tavaborole in a pharmaceutically acceptable solvent such as for example, ethyl acetate, hexane, acetone, methylene chloride, toluene, or an alcohol such as but not limited to methanol, ethanol, propanol, etc. with a co-solvent such as but not limited to water and other suitable organic solvents such as toluene, acetone, diisopropyl ether in warm conditions, subsequently cooling the material to room temperature and stirring for 2-3 h, and filtering off the solvent to obtain the desired crystalline form of tavaborole.

In accordance with some embodiments, a general procedure includes a) dissolving tavaborole in a suitable pharmaceutically acceptable organic solvent, b) heating the reaction mixture until a clear solution is obtained and crystallization with co-solvent; c) cooling the mixture to room temperature and stirring for 2-3 hours; d) filtering the crystalline product under vacuum and drying thoroughly; and e) collecting the crystalline form of tavaborole pharmaceutically acceptable solid.

In one example, an experiment was performed using water miscible solvents and water as co-solvent, as follows: a) dissolving tavaborole in a mixture of C1-C5 alcohol; b) adding water in the reaction mass under warm conditions; c) cooling the resulting clear solution to −5 to 0° C. overnight; d) filtering the crystal line product under vacuum and drying thoroughly; and e) collecting the crystalline form of tavaborole pharmaceutically acceptable solid.

Another experiment was performed by using organic solvents to crystallize the crystalline tavaborole, as follows: a) dissolving tavaborole in a suitable pharmaceutically acceptable organic solvent; b) heating the reaction mixture until a clear solution was obtained; c) cooling the mixture to room temperature and stirring for 2-3 hours; d) filtering the crystalline product under vacuum and drying thoroughly; and e) collecting the crystalline form of tavaborole pharmaceutically acceptable solid.

Form A and Form B disclosed herein have enhanced stability and dissolution properties that can be easily formulated into pharmaceutical compositions. Therefore, in further embodiments, pharmaceutical compositions include Form A or Form B tavaborole and pharmaceutically acceptable carriers and optionally pharmaceutically acceptable excipients. For example, a tavaborole topical solution may include 5% (w/w) of either Form A or Form B tavaborole in an alcohol-based solution for topical use. Each mL of a suitable pharmaceutical topical solution may contain for example 43.5 mg of tavaborole Form A or Form B, or mixtures thereof. The solution may contain alcohol, edetate calcium disodium and propylene glycol or other suitable excipients as will be well known to those skilled in the art.

### Example 1

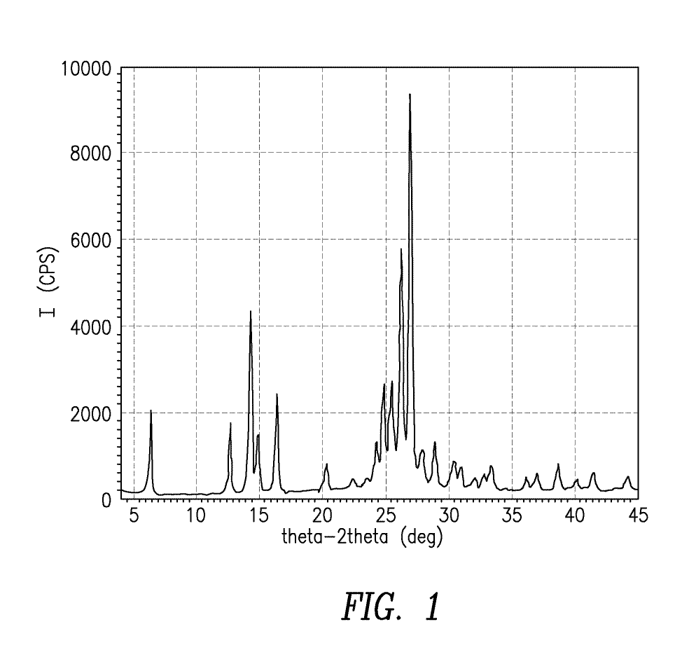

Tavaborole (20.0 g) and ethyl acetate (50.0 ml) were heated at 50-60° C. until the mixture became a clear solution, then 35 ml of hexane was added. The resulting clear solution was cooled to room temperature and stirred for 2 h. The crystalline product was filtered under vacuum, suction dried very thoroughly and further dried at 45° C. for 12 h to obtain about 15.6 g as Form A crystalline solid having an XRPD pattern as depicted in FIG. 1 and Table 1.

TABLE 1
Form A

| | | | | Intensity |
|---|---|---|---|---|
| Peak No. | 2θ (deg) | d (A) | I/I1 | (Counts) |
| 1 | 6.3263 | 13.95993 | 17 | 588 |
| 2 | 12.6448 | 6.99491 | 18 | 615 |
| 3 | 13.8800 | 6.37508 | 3 | 110 |
| 4 | 14.2828 | 6.19618 | 46 | 1594 |
| 5 | 14.8626 | 5.95574 | 15 | 518 |
| 6 | 16.3470 | 5.41812 | 24 | 856 |
| 7 | 20.2976 | 4.37161 | 7 | 236 |
| 8 | 22.3000 | 3.98339 | 2 | 81 |
| 9 | 23.3948 | 3.79939 | 1 | 41 |
| 10 | 24.1913 | 3.67607 | 10 | 332 |
| 11 | 24.7887 | 3.58882 | 24 | 839 |
| 12 | 25.4243 | 3.50052 | 24 | 855 |
| 13 | 26.1865 | 3.40033 | 58 | 2039 |
| 14 | 26.9581 | 3.30473 | 100 | 3494 |
| 15 | 27.7936 | 3.20726 | 7 | 261 |
| 16 | 28.8479 | 3.09240 | 11 | 374 |
| 17 | 30.1200 | 2.96463 | 3 | 105 |
| 18 | 30.3382 | 2.94380 | 7 | 231 |
| 19 | 30.9060 | 2.89100 | 5 | 177 |
| 20 | 31.9400 | 2.79973 | 2 | 66 |
| 21 | 32.7600 | 2.73150 | 3 | 113 |
| 22 | 33.3494 | 2.68456 | 6 | 212 |
| 23 | 36.1257 | 2.48436 | 4 | 125 |
| 24 | 36.9121 | 2.43321 | 4 | 157 |
| 25 | 38.6211 | 2.32938 | 7 | 229 |
| 26 | 39.5400 | 2.27734 | 1 | 19 |
| 27 | 39.9927 | 2.25260 | 2 | 69 |
| 28 | 40.1374 | 2.24481 | 2 | 80 |
| 29 | 40.7463 | 2.21266 | 1 | 27 |
| 30 | 41.4037 | 2.17904 | 5 | 161 |
| 31 | 44.0771 | 2.05287 | 4 | 134 |

### Example 2

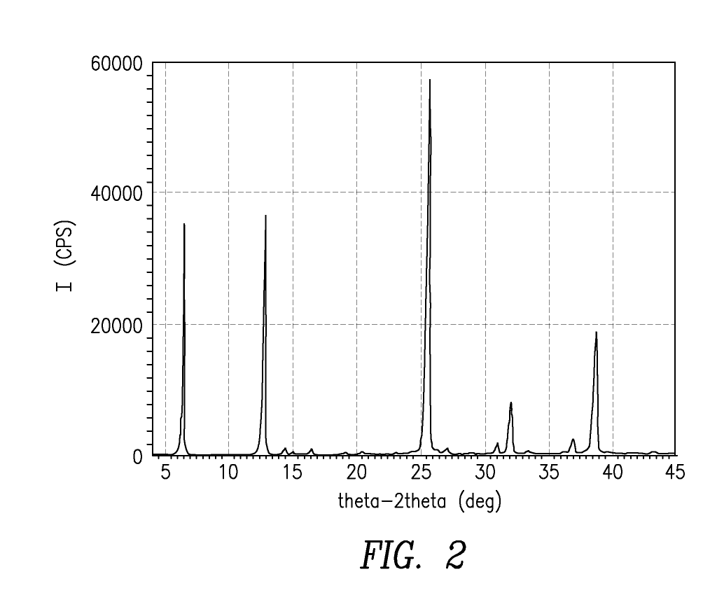

Tavaborole (22.5 g) was dissolved in 2.5 vol. of ethyl acetate (56.0 ml) in warm conditions (about 55-60° C.), the resulting clear solution was cooled to room temperature (20 to 25° C.) and stirred overnight. The crystalline product was filtered under vacuum, suction dried very thoroughly and further dried at 40-45° C. for 12 h to obtain about 13.2 g of Form B tavaborole crystalline solid. The HPLC purity of the product was over 99.9° % and had an XRPD pattern as depicted in FIG. 2 and Table 2.

TABLE 2
Form B

| | | | | Intensity |
|---|---|---|---|---|
| Peak No. | 2θ (deg) | d (A) | I/I1 | (Counts) |
| 1 | 6.3886 | 13.82394 | 41 | 8333 |
| 2 | 12.7166 | 6.95558 | 54 | 10993 |
| 3 | 14.3687 | 6.15933 | 2 | 372 |
| 4 | 14.9800 | 5.90933 | 1 | 136 |
| 5 | 16.5000 | 5.36822 | 1 | 262 |
| 6 | 19.1041 | 4.64194 | 1 | 125 |
| 7 | 20.4045 | 4.34895 | 1 | 178 |
| 8 | 22.4483 | 3.95740 | 1 | 22 |
| 9 | 23.0288 | 3.85894 | 1 | 37 |
| 10 | 25.5142 | 3.48839 | 100 | 20319 |
| 11 | 26.3318 | 3.38190 | 1 | 289 |
| 12 | 27.0840 | 3.28966 | 2 | 371 |
| 13 | 28.9200 | 3.08485 | 1 | 81 |
| 14 | 30.5260 | 2.92611 | 1 | 57 |
| 15 | 31.0219 | 2.88046 | 3 | 636 |
| 16 | 32.0484 | 2.79050 | 16 | 3228 |
| 17 | 33.4943 | 2.67327 | 1 | 186 |
| 18 | 36.2191 | 2.47816 | 1 | 56 |
| 19 | 37.0020 | 2.42751 | 5 | 945 |
| 20 | 37.3800 | 2.40382 | 1 | 59 |
| 21 | 38.6810 | 2.32592 | 37 | 7550 |
| 22 | 39.5953 | 2.27429 | 1 | 140 |
| 23 | 41.4736 | 2.17552 | 1 | 52 |
| 24 | 43.2885 | 2.08843 | 1 | 221 |
| 25 | 44.2065 | 2.04716 | 1 | 39 |

Although the compounds, schemes and methods of the present disclosure have been described with reference to exemplary embodiments thereof, the present disclosure is not limited thereby. Indeed, the exemplary embodiments are implementations of the disclosed methods are provided for illustrative and non-limitative purposes. Changes, modifications, enhancements and/or refinements to the disclosed methods may be made without departing from the spirit or scope of the present disclosure. Accordingly, such changes, modifications, enhancements and/or refinements are encompassed within the scope of the present invention. All publications, patent applications, patents, figures and other references mentioned herein are expressly incorporated by reference in their entirety.

What is claimed is:

1. Crystalline form A of tavaborole.

2. The crystalline form A of tavaborole of claim 1 having an X-ray powder diffractogram (XRPD) comprising at least one peak at diffraction 2-theta angle selected from 26.96, 26.19, and 14.28±2° theta.

3. The crystalline form A of tavaborole of claim 1 having an XPRD pattern as shown in FIG. 1.

4. Crystalline form B of tavaborole.

5. The crystalline form B of tavaborole of claim 4 having an XRPD comprising at least one peak at diffraction 2-theta angle selected from 25.51, 12.72 and 6.39±2° theta.

6. The crystalline form B of tavaborole according to claim 4 having an XPRD pattern as shown in FIG. 2.

7. A method for preparation of a pharmaceutically acceptable crystalline form of tavaborole comprising the steps of:
dissolving tavaborole in a pharmaceutically acceptable solvent to obtain a mixture;
heating the mixture until a clear solution is obtained;
cooling the clear solution;
stirring the clear solution to obtain a crystalline product;
filtering the crystalline product; and
drying the crystalline product to obtain the pharmaceutically acceptable crystalline form of tavaborole.

8. The method of claim 7 wherein the pharmaceutically acceptable solvent is selected from one or more of water, methanol, ethanol, m-propanol, IPA, n-butanol, t-butanol, tetrahydrofuran, ethyl acetate, hexane, cyclohexane, dichloromethane, toluene, didisopropyl ether and acetone.

9. The method of claim 7 wherein the pharmaceutically acceptable solvent is a mixture of C1-C5 alcohol, and further comprising adding water to the mixture under warm conditions, wherein the cooling step comprises cooling the clear solution to −5 to 0° C.

10. The method of claim 7 wherein the pharmaceutically acceptable solvent is ethyl acetate.

11. The method of claim 10 further comprising adding hexane to the heated mixture prior to the cooling step and the pharmaceutically acceptable crystalline form of tavaborole is obtained as crystalline form A.

12. The method of claim 7 consisting essentially of:
dissolving tavaborole in ethyl acetate and/or water to obtain a mixture;
heating the mixture until a clear solution is obtained;
adding hexane to the clear solution;
cooling the clear solution;
stirring the clear solution to obtain a crystalline product;
filtering the crystalline product; and
drying the crystalline product to obtain the pharmaceutically acceptable crystalline form of tavaborole.

13. The method of claim 12 wherein the tavaborole is dissolved in ethyl acetate.

14. The method of claim 11 wherein the crystalline Form A obtained has an XRPD comprising at least one peak at diffraction 2-theta angle selected from 26.96, 26.19, and 14.28±2° theta.

15. The method of claim 11 wherein the crystalline form A of tavaborole obtained has an XPRD pattern as shown in FIG. 1.

16. The method of claim 7 wherein the mixture is heated to about 55-60° C. and the clear solution is cooled to room temperature wherein the pharmaceutically acceptable crystalline form of tavaborole is obtained as crystalline form B.

17. The method of claim 16 wherein the crystalline form B obtained has an XRPD comprising at least one peak at diffraction 2-theta angle selected from 25.51, 12.72 and 6.39±2° theta.

18. The method of claim 16 wherein the crystalline form B obtained has an XPRD pattern as shown in FIG. 2.

19. The method of claim 7 consisting essentially of:
dissolving tavaborole in ethyl acetate and/or water to obtain a mixture;
heating the mixture until a clear solution is obtained;
cooling the clear solution;
stirring the clear solution to obtain a crystalline product;
filtering the crystalline product; and
drying the crystalline product to obtain the pharmaceutically acceptable crystalline form of tavaborole.

20. The method of claim 19 wherein the tavaborole is dissolved in ethyl acetate.

21. A pharmaceutical composition comprising a pharmaceutically acceptable crystalline form of tavaborole Form A and/or Form B.
